(19) United States
(12) Patent Application Publication
(10) Pub. No.: US 2007/0227074 A1
(43) Pub. Date: Oct. 4, 2007

(54) Enclosed sliding door assembly

(76) Inventor: Terry Frank, Newport, NC (US)

Correspondence Address: Niti Duggal, 2355 Drusilla Lane, Baton Rouge, LA, 70809, US

(21) Appl. No.: 11/397,294

(22) Filed: Apr. 4, 2006

(51) Int. Cl. E05D 15/16

(52) U.S. Cl. 49/409; 49/404

(57) ABSTRACT

An enclosed sliding door assembly for simply and efficiently sealing a doorway is disclosed. The enclosed sliding door assembly is further advantageous in that it has a configuration that is designed to protect its elements from environmental and corrosive conditions. The enclosed sliding door assembly comprises a housing enclosing a drive mechanism and a door movably and operatively engaged to the drive mechanism. The housing of the assembly is further configured to form a track portion that provides for both a linear length of sliding travel and a contoured length of sliding travel, respectively, for the door. The drive mechanism within the housing is further configured to cooperate with the track portion formed by the housing, such that when the drive mechanism slides the door along the track portion, the door can be moved between an open position and a closed position.

### A. BACKGROUND OF THE INVENTION

1. Field of the Invention

This invention relates to sliding doors in general and to an enclosed sliding door assembly to seal a doorway providing access to and from a refrigerated space, in particular.

2. Prior Art

Sliding door assemblies, such as those commonly found in restaurants, commercial kitchens, and supermarkets, used to seal openings between walls and refrigerated spaces are well known in the prior art, however there remains a need for their improvement. In the prior art, many sliding door assemblies are heavy, complex structures, containing numerous elements, making their utilization difficult for the user. Such sliding door assemblies are also expensive to manufacture, due to their complexity. In addition, may prior art sliding door assemblies contain exposed elements that are subject to erosion and damage. Also, many sliding door assemblies are neither safe nor reliable as their utilization often results in the accidental or inadvertent derailment of the door. Furthermore, many sliding door assemblies, in an attempt to prevent thermal exchange between the refrigerated space and the outside area, comprise heavy insulated doors and sealing gasket systems. However, these sliding door assemblies are inefficient and cumbersome to operate, as they do not prevent friction between the door and the sealing elements during sliding movement of the door, thereby resulting in friction resistance in opening and closing the door, as well as erosion and degradation of the sealing elements. Furthermore, many prior art sliding door assemblies are not versatile, being suited for a door having a specific weight and size only. Therefore, a sliding door assembly meeting the following objectives is desired.

### B. OBJECTS OF THE INVENTION

It is an object of the invention to provide an improved and simplified sliding door assembly.

It is another object of the invention to provide an improved sliding door assembly capable of being manufactured at a reduced cost.

It is another object of the invention to provide an improved sliding door assembly that allows for the simple and effective sealing engagement of a doorway providing access to a refrigerated space.

Yet another object of the invention is to provide an improved sliding door assembly that prevents friction between the door and the sealing elements during horizontal sliding movement of the door.

It is another object of the invention to provide an enclosed sliding door assembly that minimizes the exposed elements that can be subject to erosion or damage.

Another object of the invention is to provide an enclosed sliding door assembly that eliminates or substantially reduces the risk of door derailment.

It is another object of the invention to provide an improved sliding door assembly that is adaptable to doors of differing sizes and weight.

These and other objects and advantages of the invention shall become apparent from the ensuing figures and descriptions of the invention.

### C. SUMMARY OF THE INVENTION

An improved sliding door assembly is disclosed. The sliding door assembly is designed to allow for the simple and effective sealing of a doorway providing access to a refrigerated space. The sliding door assembly comprises a door having an open position and a closed position and being configured to move between the two positions. The door is further movably and operatively engaged to a drive mechanism enclosed within a housing. The housing of the assembly in turn is attachable to a wall above the doorway and further configured to form a track portion that provides for both a linear horizontal length of sliding travel and a contoured length of sliding travel, respectively, for the door. The drive mechanism situated within the housing is further configured to cooperate with the track portion formed by the housing, such that when the drive mechanism slides the door along the track portion, the door can be moved from its open position to its closed position and vice-versa.

In a preferred embodiment, the track portion formed by the housing comprises a first track section, a second track section, a first contoured ramp and a second contoured ramp. In a further preferred embodiment, the drive mechanism enclosed in the housing further comprises two pairs of rollers configured to operatively engage the top of the door, the first pair of rollers being designed and configured to slide the door along the first track section and the first contoured ramp, the second pair of rollers being designed and configured to slide the door along the second track section and the second contoured ramp.

In a preferred embodiment, the first and second track sections are designed and configured to provide a linear length of sliding travel for the door in both a first linear horizontal direction and a second linear horizontal direction. In a further preferred embodiment, the first and second contoured ramps are designed and configured to provide a first contoured length of sliding travel for the door, wherein the first contoured length of sliding travel is adjacent to the end of the sliding travel of the door in the first horizontal direction. In operation, when the door reaches the end of its sliding travel in the first horizontal direction and embarks on the first contoured length of sliding travel, the door will move in a downward and inward direction towards the doorway frame and the floor. In a preferred embodiment, the door will be bound by peripheral sealing elements, which will then contact and effect engagement with the doorway frame and the floor, upon reaching the closed position. In a further preferred embodiment, the first and second contoured ramps are further designed and configured to provide a second contoured length of sliding travel for the door, wherein the second contoured length of sliding travel is adjacent to the beginning the sliding travel of the door in the second horizontal direction. In operation, when the door is engaged in the second contoured length of sliding travel, the door will move in an upward and outward direction away from the doorway and the floor, whereby its sealing elements will then be disengaged from the doorway frame and floor. The door will then slide in the second horizontal direction, unhindered by friction resistance, toward the open position.

The enclosed sliding door assembly of the present invention provides for numerous advantages. First, the assembly allows the door to engage in smooth horizontal motion by preventing friction between the door's sealing elements and the doorway frame and floor, while allowing for an effective and proper sealing engagement of the door with the doorway and floor, when the door is closed. Second, the assembly housing, by snugly encapsulating the drive mechanism, substantially inhibits and/or prevents the derailment of the door. Third, in addition to ensuring for such safe operation, the enclosed system of the present invention also provides for an inherent benefit in that it prevents or substantially inhibits foreign matter from accumulating on the rollers, ramps, and track sections. Finally, the assembly of the present invention is versatile in that its ramps are adjustable elements, such that the length, configuration, and inclination of these elements may be varied to provide for an assembly that is capable of being utilized with a door of any given size and weight.

### D. BRIEF DESCRIPTION OF THE FIGURES

FIG. 1 depicts a front view of a preferred embodiment of the sliding door assembly of the present invention, illustrating the housing of the present invention with the hood section removed.

FIG. 1a depicts an enlarged view of the circled area of FIG. 1.

FIG. 2 depicts an end view of a preferred embodiment of the sliding door assembly of the present invention, depicting the door movably mounted to the housing.

FIGS. 3 and 4 depict additional end views of a preferred embodiment of the invention.

FIG. 5a is a perspective view of a preferred embodiment of the housing of the present invention.

FIG. 5b depicts perspective views of the preferred embodiments of the ramps of the present invention.

FIG. 6 depicts the path of sliding travel for the door in the first horizontal direction and the first contoured length of sliding travel.

FIG. 7 depicts the path of sliding travel for the door in the second horizontal direction and the second contoured length of sliding travel.

### E. DETAILED DESCRIPTION OF THE PREFERRED EMBODIMENTS OF THE INVENTION

An improved sliding door assembly 1 to seal a doorway 7 formed in a wall 6 intersecting a floor 77, whereby doorway 7 is defined by a frame 7a, and provides access to refrigerated spaces, such as those commonly found in restaurants, commercial kitchens, supermarkets, warehouses, etc, is disclosed.

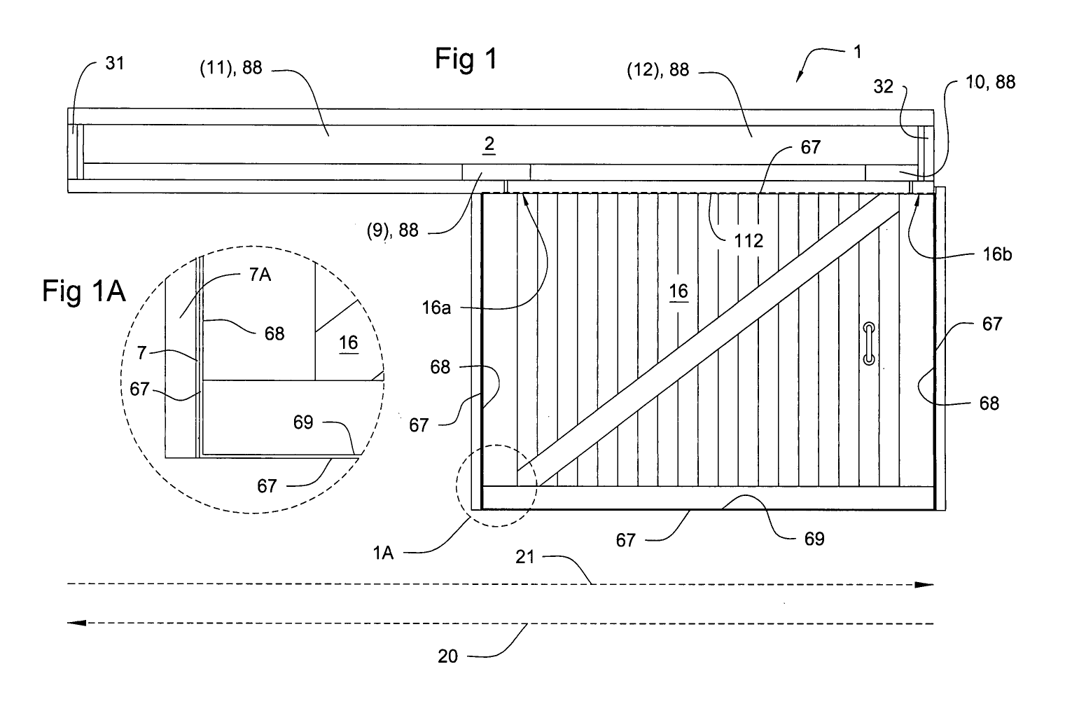

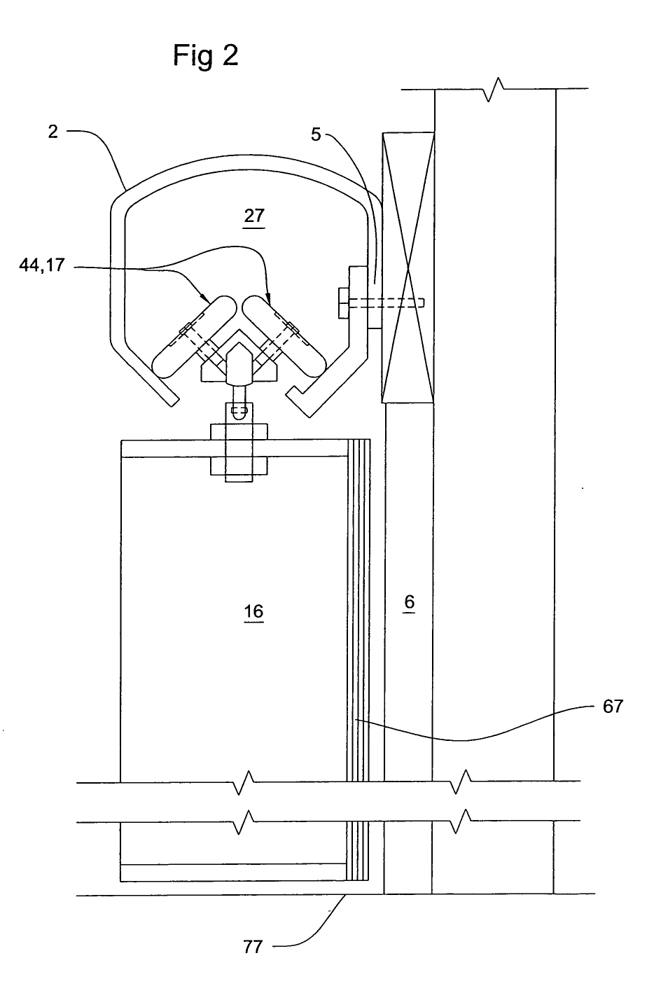

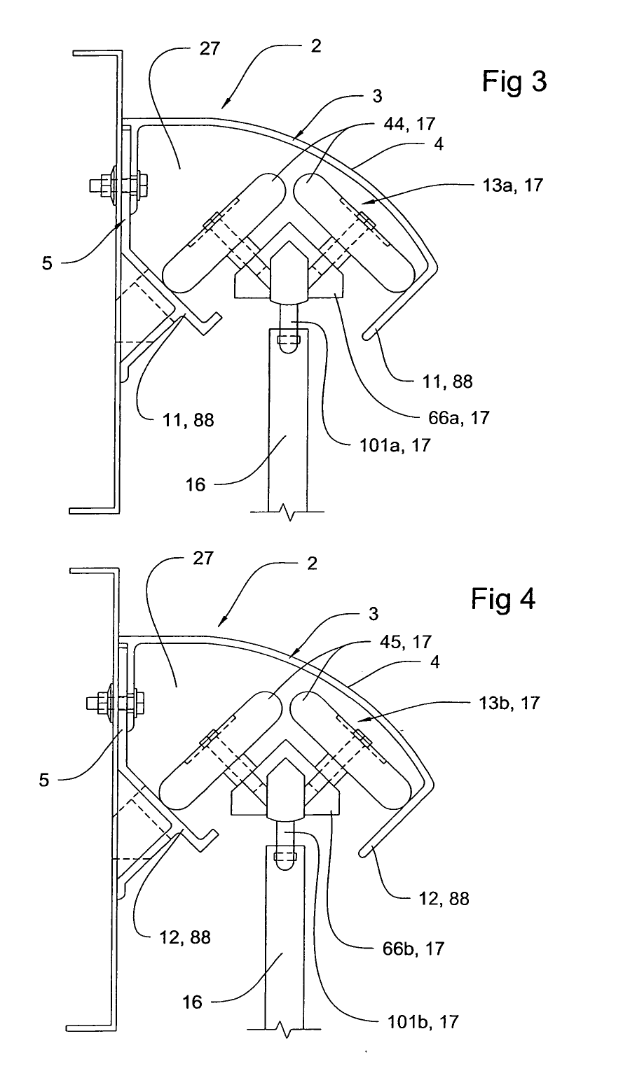

As depicted in FIG. 1, sliding door assembly 1 comprises a door 16 constructed from material providing thermal stability. Door 16 is preferably a single sliding door, alternatively door 16 can comprise one-half of a double sliding door. Door further 16 comprises a first top edge 16a and a second top edge 16b. Door 16 further has an open position 20 and a closed position 21 and is configured to move between the two positions. Sliding door assembly 1 further includes a drive mechanism 17 enclosed within a housing 2. Door 16 is movably and operatively engaged to drive mechanism 17, which in turn is configured and disposed to move door 16 along a length of sliding travel between open position 20 and closed position 21, as will be discussed further below. Preferably, sealing elements 67, such as peripheral gaskets 67, are provided to the side edges 68, top 112, and bottom 69 of door 16. As mentioned above, and as depicted in FIGS. 2, 3, 4, and 5a, assembly 1 of the present invention further comprises housing 2. Housing 2 preferably has a width that is at least twice that of doorway 7, plus housing 2 comprises an additional predetermined amount of width. In a preferred embodiment, this width is typically about 18 inches. As mentioned above, housing 2 further has an interior 27 that receives drive mechanism 17, and in addition, housing 2 forms a track portion 88 that drive mechanism 17 cooperates with to move door 16, as will be discussed further below. In constructing housing 2, the inventor contemplates using aluminum or stainless steel. However, it is anticipated that various other light-weight materials providing for durability, thermal stability, as well as a high resistance to corrosion and impact, could also be acceptable to construct housing 2. In a preferred embodiment, as depicted by FIGS. 3 and 4, housing 2 further comprises a hood section 3 preferably having an angular surface 4 that is concave to interior 27 of housing 2, and a base attachment section 5 configured to be affixed to wall 6 above doorway 7 to be sealed, to suspend housing 2 therefrom. Base section 5 may be attached to wall 6 in any manner commonly known in the prior art, such as via pins, fasteners, bolts, welding, clamps, etc., that results in a stable and level attachment of housing 2 to wall 6. In a preferred embodiment, hood section 3 is a removable element of housing 2, such that hood section 3 may be easily detached when cleaning and/or maintenance of the enclosed drive mechanism 17 within housing 2 is desired. Drive mechanism 17 will be discussed in further detail below.

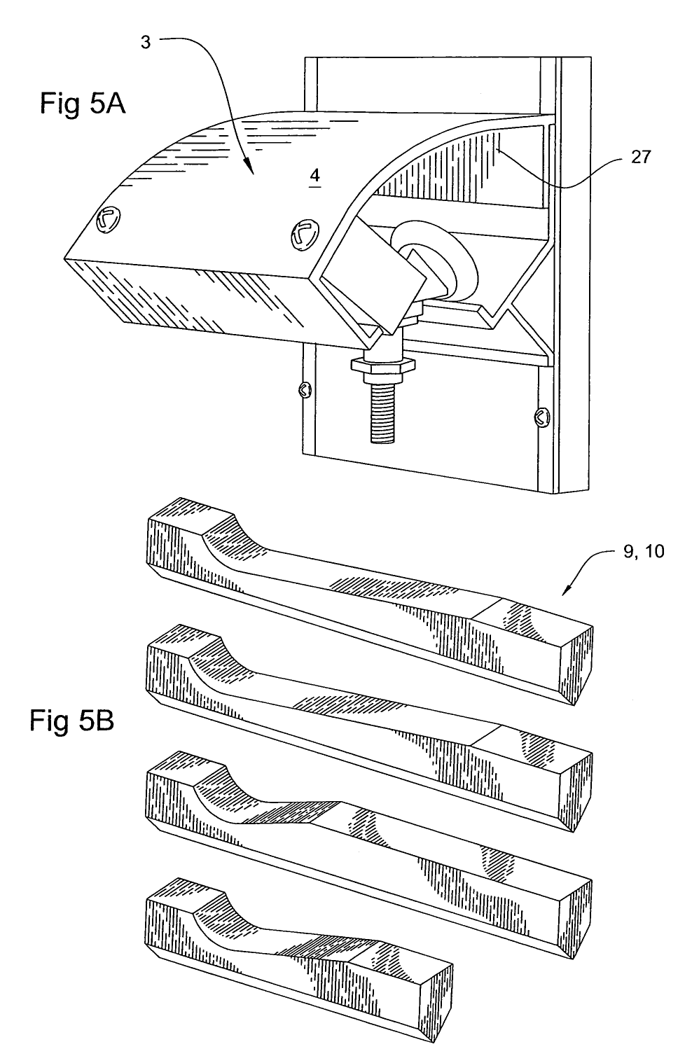

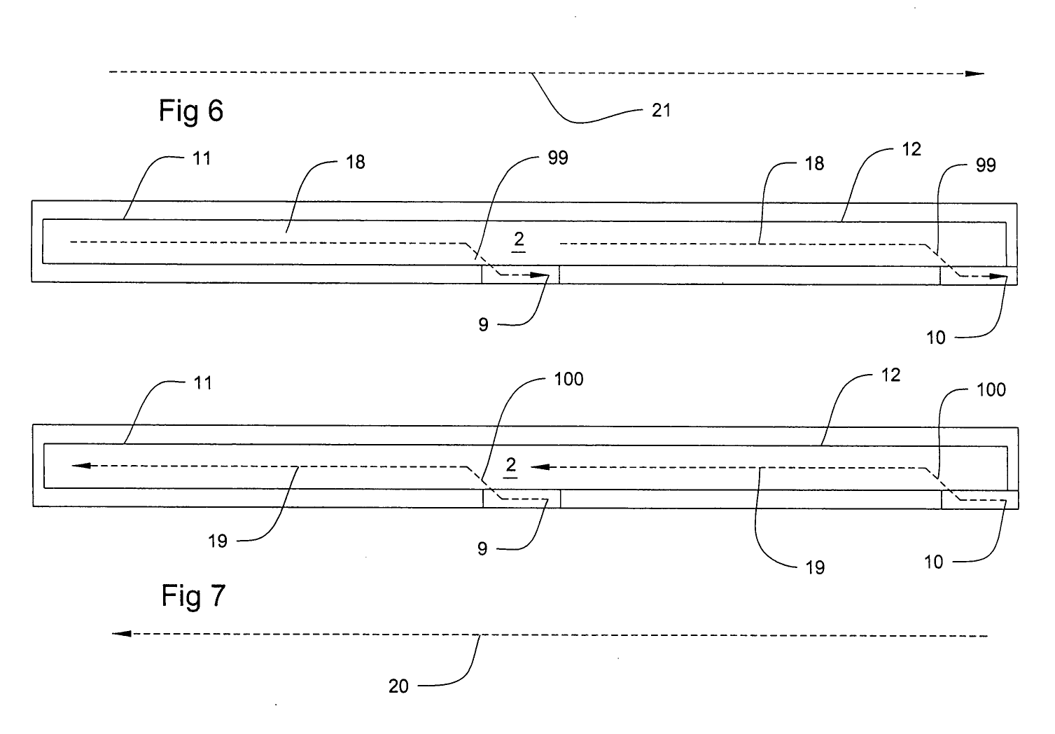

Turning now to a discussion of track portion 88 formed by housing 2, in a preferred embodiment, and as depicted by FIGS. 1, 3 and 4, track portion 88 comprises a first track section 11, a second track section 12, a first contoured ramp 9 and a second contoured ramp 10. In a preferred embodiment, and as depicted in FIGS. 6 and 7, track sections 11, and 12 and ramps 9 and 10 are elongated in the sliding path of door 16. In a preferred embodiment, and as will be discussed further below, track sections 11 and 12 together provide for a linear length of sliding travel for door 16, in a first horizontal direction 18 and in a second horizontal direction 19. In a further preferred embodiment, and as depicted in FIG. 1, first contoured ramp 9 is situated between track sections 11 and 12 and second contoured ramp 10 is situated at the end of track section 12. As depicted in FIGS. 6 and 7, and as will be discussed further below, ramps 9 and 10 together provide for a first contoured length of sliding travel 99 and a second contoured length of sliding travel 100 for door 16. First contoured length of sliding travel 99 is preferably adjacent to the end of the sliding travel of door 16 in first horizontal direction 18. When door 16 is engaged in first contoured length of sliding travel 99, door 16 will move downward and inward towards doorway 7 and floor 77, reaching the closed position 21. As will be discussed further below, and as depicted in FIGS. 6 and 7, second contoured length of sliding travel 100 is preferably adjacent to the beginning of sliding travel of door 16 in second horizontal direction 19. When door 16 is engaged in second contoured length of sliding travel 100, door 16 will move upward and outward away from doorway 7 and floor 77, heading toward open position 20. In constructing ramps 9 and 10, the inventor contemplates using polyvinyl chloride blocks, however other plastic or rubber based materials having the desired characteristics of durability and resilience may also be utilized. In a further preferred embodiment, ramps 9 and 10 are detachable elements and assembly 1 is provided with a plurality of ramps having different configurations as depicted by FIG. 5b. In this manner, different ramps suitable for use with different doors may be disposed appropriately within housing 2, in accordance with the door desired to be mounted, such that assembly 1 is capable of being utilized with doors having differing sizes and weight. In a preferred embodiment, and as depicted in FIG. 1, housing 2 of assembly 1 further comprises end caps 31 and 32 disposed at each end of housing 2 to retain first and second track sections 11 and 12, and contoured ramps 9 and 10 within housing 2.

Turning now to a discussion of drive mechanism 17 enclosed in housing 2, and as depicted by FIGS. 2, 3, and 4, drive mechanism 17 includes two trolley assemblies 13a and 13b disposed within housing 2. Trolley assembly 13a preferably comprises a first pair of rollers 44 and trolley assembly 13b comprises a second pair of rollers 45. In a preferred embodiment, rollers 44 are preferably identical and configured to have a V-shape. In a further preferred embodiment, rollers 45 are also preferably identical and configured to have a V-shape. Rollers 44 and 45 are preferably constructed from nylon, rubber, or any other appropriate synthetic material providing for resistance to impact, abrasion, and corrosion, while simultaneously providing for maximum durability and a smooth rolling movement. In a preferred embodiment, rollers 44 are angularly positioned within housing 2, and cooperate with first track section 11 and first contoured ramp 9. In a further preferred embodiment, rollers 45 are also angularly positioned within housing 2, and cooperate with second track section 12 and second contoured ramp 10. In a preferred embodiment, rollers 44 and 45 are further provided with shafts and bearing means to allow them to rotate along track sections 11 and 12 and contoured ramps 9 and 10, respectively. In constructing shafts and bearing means, the inventor contemplates using aluminum, stainless steel, or any other appropriate material providing for durability and a high resistance to corrosion and impact.

Continuing the discussion of trolley assemblies 13a and 13b of drive mechanism 17, in a preferred embodiment, and as depicted by FIGS. 2, 3, and 4, trolley assemblies 13a and 13b comprise a first trolley chassis 66a and a second trolley chassis 66b, respectively. In a preferred embodiment, first pair of rollers 44 is affixed to first trolley chassis 66a which in turn is attached to a first hanger bolt 101a. First hanger bolt 101a is configured to engage the first top edge 16a of door 16. In a further preferred embodiment, second pair of rollers 45 is affixed to second trolley chassis 66b, which in turn is attached to a second hanger bolt 101b configured to engage the second top edge 16b of door 16. Thus, in this fashion, door 16 is movably mounted to drive assembly 17 in an orientation that is level with, and parallel to, doorway 7, with sufficient clearance distance between peripheral gaskets 67 of door 16 and the doorway frame 7a and floor 77. In a preferred embodiment, first and second trolley chassis 66a and 66b are constructed from aluminum, stainless steel, or any other appropriate material having corrosion and impact-resistant characteristics.

As depicted by FIGS. 6 and 7, an exemplary manner of operation of assembly 1 will now be set forth. Once door 16 is mounted to housing 2, as described above, door 16 may be mechanically or manually moved from open position 20 toward closed position 21. When door 16 is moved from open position 20 toward closed position 21, rollers 44 of drive assembly 17 will move along track section 11 formed by housing 2 and rollers 45 of drive assembly 17 will move along track section 12 formed by housing 2. Rollers 44 and 45 will move in a level linear path along track sections 12 and 13, respectively, causing door 16 to slide in first horizontal direction 18, as depicted by FIG. 6. When door 16 is traveling in this orientation, there is sufficient clearance between peripheral gaskets 67 of door 16 and doorway frame 7a and floor 77, such that peripheral gaskets 67 do not contact doorway frame 7a or floor 77. Thus, this will allow door 16 to engage in a horizontal and linear sliding motion, without encountering friction resistance. As door 16 approaches the end of sliding travel in first horizontal direction 18 and approaches closed position 21, rollers 44 will move off of track section 11 and onto contoured ramp 9, and rollers 45 will move off of track section 12 and onto contoured ramps 10, respectively. The risk of door derailment at this point is minimized, as the angular position of rollers 44 and 45 and the communicating angles of contoured ramps 9 and 10, in conjunction with hood section 3 of housing 2, will substantially inhibit and/or prevent such an incident from occurring. As rollers 44 and 45 move onto respective contoured ramps 9 and 10, this will cause door 16 to drop at an incline. Door 16 will then slide in first contoured length of travel 99, i.e. in a downwards and inwards direction, as depicted by FIG. 6, towards doorway frame 7a and floor 77, whereby peripheral gaskets 67 of door 16 will then come into contact with same to provide a sealing engagement of door 16 with doorway 7 and floor 77, when door 16 is in closed position 21. This sealing engagement, in conjunction with the insulation provided by door 16 and housing 2, will substantially inhibit and/or prevent thermal exchange between the refrigerated space and the area outside it. When door 16 is moved back towards open position 20, rollers 44 and 45 will move in a reverse direction, i.e. rollers 45 will move off of contoured ramp 10 and rollers 44 will move off of contoured ramp 9, respectively. This will cause door 16 to slide in a second contoured length of travel 100, i.e. in an upwards and outwards direction away from doorway 7 and floor 77, as depicted by FIG. 7, thereby disengaging gaskets 67 of door 16 from doorway frame 7a and floor 77. Rollers 45 and 44 will then move along track sections 12 and 11 respectively, in a level and linear path, causing door 16 to slide in second horizontal direction 19, unhindered by friction resistance, towards open position 20. Though the above operation depicts an embodiment where sealing gaskets 67 are mounted to door 16, other appropriate sealing arrangements may also be utilized, for e.g., peripheral gaskets 67 may be mounted to the boundary of doorway frame 7a instead, or to both doorway frame 7a and door 16.

In summary, assembly 1 of the present invention allows for door 16 to be quickly and smoothly moved from open position 20 to closed position 21, and vice-versa, without friction resistance, while simultaneously allowing for a firm and insulated sealing of doorway 7 when door 16 is in closed position 21. Furthermore, as also mentioned above, the construction and design of assembly 1 minimizes the risk of derailment during sliding movement of door 16. In addition to providing for a safe and efficient door operation, the hooded design of assembly 1 minimizes the exposure of its enclosed elements to environmental and corrosive conditions and inhibits dirt, debris, water etc., from settling and accumulating on rollers 44 and 45, track sections 11 and 12, and ramps 9 and 10. This in turn prolongs the life span of the elements, and increases the efficiency of operation of assembly 1. In addition, the simplified construction of assembly 1 makes it capable of being manufactured at reduced cost.

While the invention has been described in terms of its preferred embodiment, other embodiments will be apparent to those of skill in the art from a review of the foregoing. Those embodiments as well as the preferred embodiments are intended to be encompassed by the scope and spirit of the following claims.

I claim:

1. A sliding door assembly for sealing a doorway formed in a wall comprising:
a.) a door having an open position and a closed position, the door further being configured to move between the open position and the closed position;
b.) the door movably engaged to a drive mechanism configured and disposed to move the door along a length of sliding travel between the open position and the closed position;
c.) a housing configured to be attached to the wall above the doorway, the housing further configured to receive the drive mechanism, the housing further configured to form a track portion to provide the length of sliding travel for the door;
d.) the drive mechanism configured to cooperate with the track portion, such that when the drive mechanism slides the door along the track portion, the door can be moved between the open position and the closed position.

2. A sliding door assembly for sealing a doorway formed in a wall that intersects a floor comprising:
a.) a door having an open position and a closed position, the door further being configured to move between the open position and the closed position;
b.) the door movably engaged to a drive mechanism configured and disposed to move the door along a length of sliding travel between the open position and the closed position;
c.) a housing configured to be attached to the wall above the doorway, the housing further configured to receive the drive mechanism, the housing further configured to form a track portion to provide the length of sliding travel for the door;
d.) the drive mechanism configured to cooperate with the track portion, such that when the drive mechanism slides the door along the track portion, the door can be moved between the open position and the closed position;
e.) the track portion formed by the housing further configured and disposed to provide a linear length of sliding travel for the door in a first horizontal direction;
f.) the track portion formed by the housing further configured and disposed to provide a linear length of sliding travel for the door in a second horizontal direction;
g.) the track portion formed by the housing further configured and disposed to provide a first contoured length of sliding travel for the door, wherein the first contoured length of sliding travel is adjacent to the end of the sliding travel of the door in the first horizontal direction, whereby when the door reaches the end of its sliding travel in the first horizontal direction and embarks on the first contoured length of sliding travel, the door will move in a downward and inward direction towards the doorway and floor, reaching the closed position;
h.) the track portion further disposed and configured to provide a second contoured length of sliding travel for the door, wherein the second contoured length of sliding travel is adjacent to the beginning the sliding travel of the door in the second horizontal direction, whereby when the door is engaged in the second contoured length of sliding travel, the door will move in an upward and outward direction away from the doorway and the floor, to then slide in the second horizontal direction toward the open position;

3. The sliding door assembly according to claim 2, wherein the doorway is defined by a frame, wherein the door is bound by sealing elements, and wherein the sealing elements effect sealing between the door and the doorway frame and floor, when the door reaches the closed position.

4. The sliding door assembly according to claim 3, wherein the sealing elements are disengaged from the doorway frame and floor when the door completes the second contoured length of sliding travel.

5. A sliding door assembly for sealing a doorway formed in a wall that intersects a floor comprising:
a.) a door having an open position and a closed position, the door further being configured to move between the open position and the closed position;
b.) the door movably engaged to a drive mechanism configured and disposed to move the door along a length of sliding travel between the open position and the closed position;
c.) a housing configured to be attached to the wall above the doorway, the housing further configured to receive the drive mechanism, the housing further configured to form a track portion to provide the length of sliding travel for the door;
d.) the drive mechanism configured to cooperate with the track portion, such that when the drive mechanism slides the door along the track portion, the door can be moved between the open position and the closed position;
e.) the track portion of the drive mechanism comprising a first track section, a second track section, a first contoured ramp, and a second contoured ramp;
f.) the first and second track sections designed and configured to provide a linear length of sliding travel for the door in a first horizontal direction,;
g.) the first and second track sections further designed and configured to provide a linear length of sliding travel for the door in a second horizontal direction;
h.) the first and second contoured ramps designed and configured to provide a first contoured length of sliding travel for the door, wherein the first contoured length of sliding travel is adjacent to the end of the sliding travel of the door in the first horizontal direction, whereby when the door reaches the end of its sliding travel in the first horizontal direction and embarks on the first contoured length of sliding travel, the door will move in a downward and inward direction towards the doorway and floor, reaching the closed position;
i.) the first and second contoured ramps further designed and configured to provide a second contoured length of sliding travel for the door, wherein the second contoured length of sliding travel is adjacent to the beginning the sliding travel of the door in the second horizontal direction, whereby when the door is engaged in the second contoured length of sliding travel, the door will move in an upward and outward direction away from the doorway and the floor, to then slide in the second horizontal direction toward the open position;
j.) the drive mechanism further comprising a first pair of rollers configured to cooperate with the first track section and the first contoured ramp, the drive mechanism further comprising a second pair of rollers configured to cooperate with the second track section and the second contoured ramp, wherein the first pair of rollers and the second pair of rollers are configured to operatively engage the door;

6. The sliding door assembly according to claim 5, wherein the assembly further comprises an end cap disposed at each end of the housing.

7. The sliding door assembly according to claim 5, wherein the housing comprises a hood section having an angular surface.

8. The housing according to claim 5, wherein the hood section is removable.

9. The sliding door assembly according to claim 5, wherein the housing comprises a base attachment section designed and configured to suspend the housing from the wall.

10. The sliding door assembly according to claim 5, wherein the first pair of rollers is affixed to a first trolley chassis, and wherein the second pair of rollers is affixed to a second trolley chassis, wherein the first trolley chassis and second trolley chassis are configured to operatively engage the door.

11. The sliding door assembly according to claim 5, wherein the ramps are detachable elements.

12. The sliding door assembly according to claim 5, wherein the assembly is provided with a plurality of ramps having different configurations.

13. The sliding door assembly according to claim 5, wherein the doorway is defined by a frame, wherein the door is bound by sealing elements, and wherein the sealing elements effect sealing between the door and the doorway frame and floor when the door reaches the closed position.

14. The sliding door assembly according to claim 13, wherein the sealing elements are disengaged from the doorway frame and floor when the door completes the second contoured length of sliding travel.
